(19) United States
(12) Patent Application Publication
(10) Pub. No.: US 2026/0341196 A1
(43) Pub. Date: Oct. 29, 2026

(54) DISPLAY DEVICE, PIXEL INCLUDED IN THE SAME, AND ELECTRONIC DEVICES INCLUDING THE SAME

(71) Applicant: Samsung Display Co., Ltd., Yongin-si (KR)

(72) Inventors: JIYOUNG LEE, Yongin-si (KR); HYUNYOUNG CHOI, Yongin-si (KR); HYUNG UK CHO, Yongin-si (KR)

(21) Appl. No.: 19/390,285

(22) Filed: Nov. 14, 2025

(30) Foreign Application Priority Data
Apr. 24, 2025 (KR) 10-2025-0053476

(51) Int. Cl. G09G 3/32; G09G 3/3266; G09G 3/3275

(52) U.S. Cl. CPC G09G 3/32; G09G 3/3266; G09G 3/3275; G09G 2300/043; G09G 2300/0819; G09G 2310/0267; G09G 2310/0275; G09G 2310/08

(57) ABSTRACT

A display device includes a display panel including pixels, a gate driver, an emission driver, and a data driver. The pixel includes a light-emitting element including a first terminal and a second terminal receiving a low power voltage, a first transistor including a gate connected to a first node, a first terminal receiving a high power voltage, and a second terminal connected to a second node, a second transistor transmitting a data signal to a third node, a third transistor connecting the first node to the second node, a fourth transistor transmitting a reference voltage to the first node or the second node or connecting the second node to the third node, a fifth transistor connecting the second node to the first terminal of the light-emitting element, and a first capacitor connected between the first node and the third node.

### CROSS-REFERENCE TO RELATED APPLICATION

The present application claims priority to and the benefit of Korean Patent Application No. 10-2025-0053476, filed on Apr. 24, 2025, in the Korean Intellectual Property Office, the entire disclosure of which is incorporated herein by reference.

### BACKGROUND

### 1. Field

Aspects of some embodiments relate to a display device, a pixel included in the same, and electronic devices including the same.

### 2. Description of the Related Art

A display device may include a display panel, a gate driver, and a data driver. The display panel may include pixels, the gate driver may provide gate signals to each of the pixels, and the data driver may provide data voltages to each of the pixels.

The pixel may include a light-emitting element that emits light based on a driving current and a plurality of transistors including a driving transistor that generates the driving current. As the number of transistors included in the pixel increases, an area of the pixel may increase, and the implementation of a high-resolution display device may be limited.

When a difference exists between threshold voltages of the driving transistors of the pixels, a difference between luminances of the pixels may occur. Accordingly, the threshold voltage of the driving transistor may be compensated to reduce the difference between the threshold voltages of the driving transistors.

The above information disclosed in this Background section is only for enhancement of understanding of the background and therefore the information discussed in this Background section does not necessarily constitute prior art.

### SUMMARY

Aspects of some embodiments of the present disclosure relate to a display device, a pixel included in the same, and electronic devices including the same. For example, aspects of some embodiments relate to a display device including a pixel including a plurality of transistors and an electronic device including a display device that displays an image.

Aspects of some embodiments include a display device with a relatively high resolution, a pixel in which a threshold voltage of a driving transistor is compensated, and an electronic device including the display device with the high resolution.

A display device according to some embodiments includes a display panel including pixels, a gate driver that provides a write gate signal, a compensation gate signal, and an initialization gate signal to each of the pixels, an emission driver that provides an emission signal to each of the pixels, and a data driver that provides a data signal to each of the pixels. According to some embodiments, each of the pixels includes a light-emitting element including a first terminal and a second terminal that receives a low power voltage, a first transistor including a gate connected to a first node, a first terminal that receives a high power voltage having a voltage level higher than a voltage level of the low power voltage, and a second terminal connected to a second node, a second transistor that transmits the data signal to a third node in response to the write gate signal, a third transistor that connects the first node to the second node in response to the compensation gate signal, a fourth transistor that transmits a reference voltage to the first node or the second node or connects the second node to the third node in response to the initialization gate signal, a fifth transistor that connects the second node to the first terminal of the light-emitting element in response to the emission signal, and a first capacitor connected between the first node and the third node.

According to some embodiments, the fourth transistor may connect a data line that transmits the data signal having the reference voltage to the first node in response to the initialization gate signal.

According to some embodiments, in an initialization period, the data signal may have the reference voltage, and each of the compensation gate signal, the initialization gate signal, the write gate signal, and the emission signal may have an activation voltage level.

According to some embodiments, in a compensation period, the data signal may have the reference voltage, each of the compensation gate signal and the write gate signal may have an activation voltage level, and each of the initialization gate signal and the emission signal may have a deactivation voltage level.

According to some embodiments, in a writing period, the data signal may have a data voltage, the write gate signal may have an activation voltage level, and each of the compensation gate signal, the initialization gate signal, and the emission signal may have a deactivation voltage level.

According to some embodiments, in an emission period, the data signal may have the reference voltage, the emission signal may have an activation voltage level, and each of the compensation gate signal, the initialization gate signal, and the write gate signal may have a deactivation voltage level.

According to some embodiments, each of the pixels may further include a second capacitor connected between the third node and a power line that transmits the high power voltage.

According to some embodiments, each of the pixels may further include a sixth transistor that transmits the low power voltage to the first terminal of the light-emitting element in response to a bypass gate signal.

According to some embodiments, the bypass gate signal may have an activation voltage level in an initialization period, a compensation period, and a writing period, and may have a deactivation voltage level in an emission period.

According to some embodiments, each of the pixels may further include a sixth transistor that transmits an initialization voltage to the first terminal of the light-emitting element in response to a bypass gate signal.

According to some embodiments, each of the pixels may further include a second capacitor connected between the first node and a power line that transmits the high power voltage.

According to some embodiments, the fourth transistor may connect a data line that transmits the data signal having the reference voltage to the second node in response to the initialization gate signal.

According to some embodiments, the fourth transistor may connect a reference line that transmits the reference voltage to the second node in response to the initialization gate signal.

According to some embodiments, the fourth transistor may connect the second node to the third node in response to the initialization gate signal.

A pixel according to some embodiments includes a light-emitting element including a first terminal and a second terminal that receives a low power voltage, a first transistor including a gate connected to a first node, a first terminal that receives a high power voltage having a voltage level higher than a voltage level of the low power voltage, and a second terminal connected to a second node, a second transistor that transmits a data signal to a third node in response to a write gate signal, a third transistor that connects the first node to the second node in response to a compensation gate signal, a fourth transistor that transmits a reference voltage to the first node or the second node or connects the second node to the third node in response to an initialization gate signal, a fifth transistor that connects the second node to the first terminal of the light-emitting element in response to an emission signal, and a first capacitor connected between the first node and the third node.

According to some embodiments, the fourth transistor may connect a data line that transmits the data signal having the reference voltage to the first node in response to the initialization gate signal.

According to some embodiments, the pixel may further include a second capacitor connected between the third node and a power line that transmits the high power voltage.

According to some embodiments, the fourth transistor may connect a data line that transmits the data signal having the reference voltage to the second node in response to the initialization gate signal.

According to some embodiments, the fourth transistor may connect the second node to the third node in response to the initialization gate signal.

An electronic device according to some embodiments includes a processor that generates input image data, a display device that displays an image based on the input image data, and a power module connected to the processor and the display device. According to some embodiments, the display device includes a display panel including pixels, a gate driver that provides a write gate signal, a compensation gate signal, and an initialization gate signal to each of the pixels, an emission driver that provides an emission signal to each of the pixels, and a data driver that provides a data signal to each of the pixels. According to some embodiments, each of the pixels includes a light-emitting element including a first terminal and a second terminal that receives a low power voltage, a first transistor including a gate connected to a first node, a first terminal that receives a high power voltage having a voltage level higher than a voltage level of the low power voltage, and a second terminal connected to a second node, a second transistor that transmits the data signal to a third node in response to the write gate signal, a third transistor that connects the first node to the second node in response to the compensation gate signal, a fourth transistor that transmits a reference voltage to the first node or the second node or connects the second node to the third node in response to the initialization gate signal, a fifth transistor that connects the second node to the first terminal of the light-emitting element in response to the emission signal, and a first capacitor connected between the first node and the third node.

In the pixel, the display device, and the electronic device according to some embodiments, the pixel includes a relatively small number of transistors, so that an area of the pixel may be relatively decreased, and the resolution of the display device may relatively increase. Further, the pixel compensates the threshold voltage of the driving transistor in a diode-connection manner, so that an image quality of the display device may be relatively improved.

### BRIEF DESCRIPTION OF THE DRAWINGS

Illustrative, non-limiting embodiments will be more clearly understood from the following detailed description taken in conjunction with the accompanying drawings.

FIG. 1 is a block diagram illustrating aspects of a display device according to some embodiments.

FIG. 2 is a circuit diagram illustrating aspects of an example of a pixel of FIG. 1.

FIG. 3 is a timing diagram illustrating aspects of an example of signals of FIG. 2.

FIG. 4 is a diagram for describing an initialization period of FIG. 3.

FIG. 5 is a diagram for describing a compensation period of FIG. 3.

FIG. 6 is a diagram for describing a writing period of FIG. 3.

FIG. 7 is a diagram for describing an emission period of FIG. 3.

FIG. 8 is a circuit diagram illustrating aspects of a pixel according to some embodiments.

FIG. 9 is a circuit diagram illustrating aspects of a pixel according to some embodiments.

FIG. 10 is a timing diagram illustrating an example of signals of FIG. 10.

FIG. 11 is a circuit diagram illustrating aspects of a pixel according to some embodiments.

FIG. 12 is a circuit diagram illustrating aspects of a pixel according to some embodiments.

FIG. 13 is a circuit diagram illustrating aspects of a pixel according to some embodiments.

FIG. 14 is a circuit diagram illustrating aspects of a pixel according to some embodiments.

FIG. 15 is a circuit diagram illustrating aspects of a pixel according to some embodiments.

FIG. 16 is a circuit diagram illustrating aspects of a pixel according to some embodiments.

FIG. 17 is a circuit diagram illustrating aspects of a pixel according to some embodiments.

FIG. 18 is a circuit diagram illustrating aspects of a pixel according to some embodiments.

FIG. 19 is a circuit diagram illustrating aspects of a pixel according to some embodiments.

FIG. 20 is a circuit diagram illustrating aspects of a pixel according to some embodiments.

FIG. 21 is a circuit diagram illustrating aspects of a pixel according to some embodiments.

FIG. 22 is a circuit diagram illustrating aspects of a pixel according to some embodiments.

FIG. 23 is a circuit diagram illustrating aspects of a pixel according to some embodiments.

FIG. 24 is a block diagram illustrating aspects of an electronic device according to some embodiments.

FIG. 25 is a diagram illustrating aspects of electronic devices according to some embodiments.

### DETAILED DESCRIPTION

Hereinafter, a display device, a pixel, and an electronic device according to some embodiments of the present disclosure will be described in more detail with reference to the accompanying drawings. The same or similar reference numerals will be used for the same elements in the accompanying drawings.

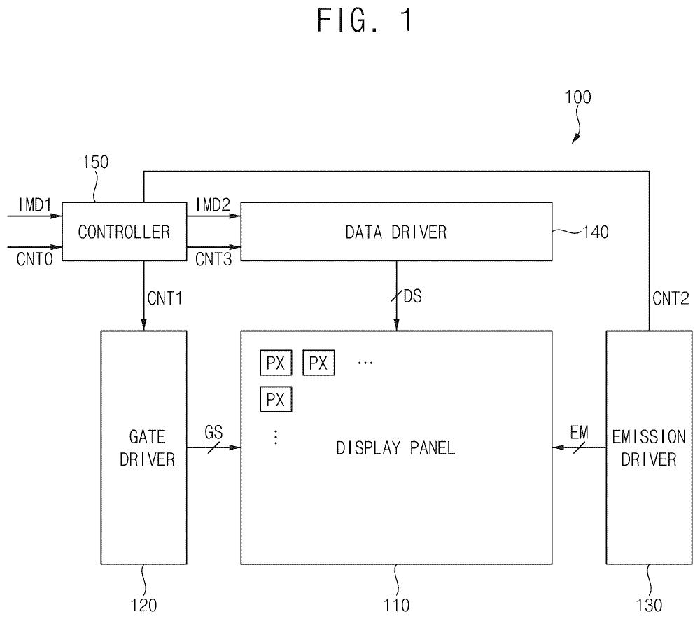

FIG. 1 is a block diagram illustrating a display device 100 according to some embodiments.

Referring to FIG. 1, the display device 100 may include a display panel 110, a gate driver 120, an emission driver 130, a data driver 140, and a controller 150.

The display panel 110 may include pixels PX. Each of the pixels PX may emit light based on a gate signal GS, an emission signal EM, and a data signal DS.

The gate driver 120 may provide the gate signal GS to each of the pixels PX. The gate driver 120 may generate the gate signal GS on a pixel row basis. The gate driver 120 may generate the gate signal GS based on a first control signal CNT1. The first control signal CNT1 may include a gate start signal, a gate clock signal, and the like.

The emission driver 130 may provide the emission signal EM to each of the pixels PX. The emission driver 130 may generate the emission signal EM on a pixel row basis. The emission driver 130 may generate the emission signal EM based on a second control signal CNT2. The second control signal CNT2 may include an emission start signal, an emission clock signal, and the like.

The data driver 140 may provide the data signal DS to each of the pixels PX. The data driver 140 may generate the data signal DS based on output image data IMD2 and a third control signal CNT3. The data driver 140 may convert the digital output image data IMD2 into the analog data signal DS. The third control signal CNT3 may include a load signal, a data clock signal, an output data enable signal, and the like.

The controller 150 may control the gate driver 120, the emission driver 130, and the data driver 140. The controller 150 may provide the first control signal CNT1 to the gate driver 120, may provide the second control signal CNT2 to the emission driver 130, and may provide the output image data IMD2 and the third control signal CNT3 to the data driver 140. The controller 150 may generate the output image data IMD2, the first control signal CNT1, the second control signal CNT2, and the third control signal CNT3 based on input image data IMD1 and input control signal CNT0. According to some embodiments, the input image data IMD1 may include red image data, green image data, and blue image data. The input control signal CNT0 may include a vertical synchronization signal, a horizontal synchronization signal, a master clock signal, an input data enable signal, and the like.

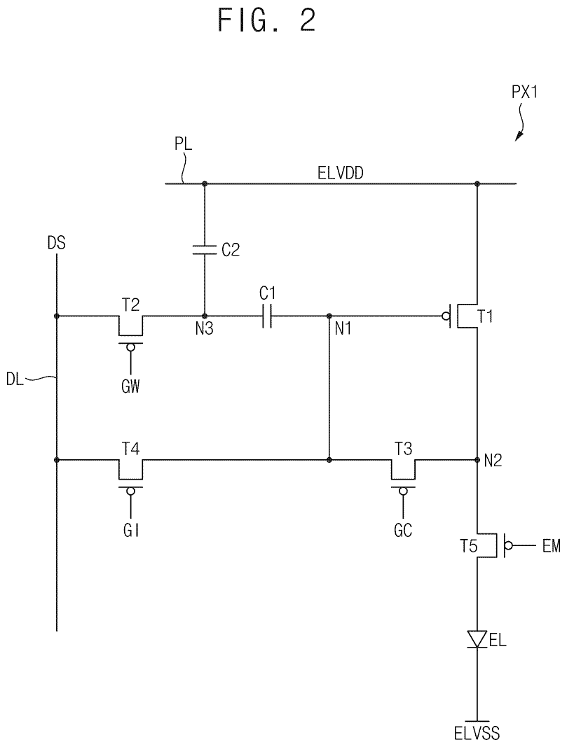

FIG. 2 is a circuit diagram illustrating aspects of an example of the pixel PX of FIG. 1. Although FIG. 2 illustrates various components in a pixel PX according to some embodiments, embodiments according to the present disclosure are not limited thereto, and according to various embodiments, the pixel may include additional components, or fewer components, without departing from the spirit and scope of embodiments according to the present disclosure.

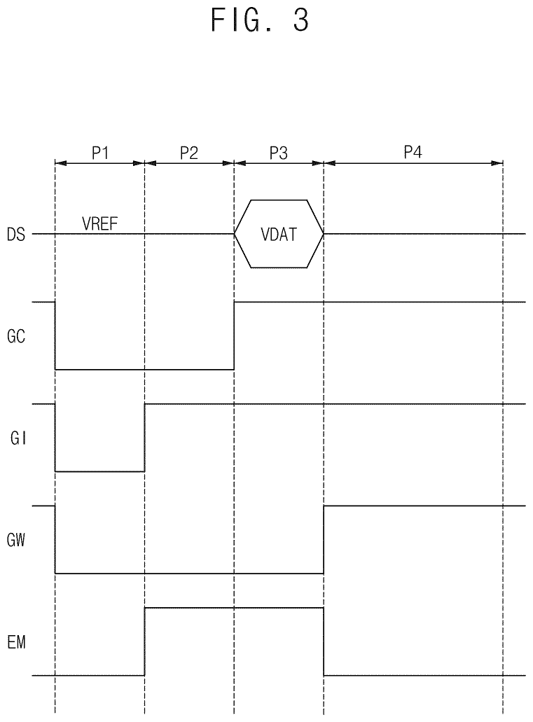

FIG. 3 is a timing diagram illustrating an example of signals DS, GC, GI, GW, and EM of FIG. 2.

Referring to FIGS. 2 and 3, the pixel PX1 may receive a write gate signal GW, a compensation gate signal GC, an initialization gate signal GI, the emission signal EM, the data signal DS, a high power voltage ELVDD, and a low power voltage ELVSS. The gate signal GS of FIG. 1 may include the write gate signal GW, the compensation gate signal GC, and the initialization gate signal GI. The data signal DS may have a reference voltage VREF and a data voltage VDAT. A voltage level (e.g., 7 volts (V) or about 7 V) of the high power voltage ELVDD may be higher than a voltage level (e.g., 0 V or about 0 V) of the low power voltage ELVSS. The pixel PX1 may include a light-emitting element EL, a first transistor T1, a second transistor T2, a third transistor T3, a fourth transistor T4, a fifth transistor T5, a first capacitor C1, and a second capacitor C2.

The light-emitting element EL may include a first terminal (e.g., an anode) and a second terminal (e.g., a cathode) that receives the low power voltage ELVSS. According to some embodiments, the light-emitting element EL may be one of an organic light-emitting diode, an inorganic light-emitting diode, a quantum dot light-emitting diode, and a micro light-emitting diode.

The first transistor T1 may include a gate connected to a first node N1, a first terminal that receives the high power voltage ELVDD, and a second terminal connected to a second node N2.

The second transistor T2 may transmit the data signal DS to a third node N3 in response to the write gate signal GW. The second transistor T2 may include a gate that receives the write gate signal GW, a first terminal connected to a data line DL that transmits the data signal DS, and a second terminal connected to the third node N3.

The third transistor T3 may connect the first node N1 to the second node N2 in response to the compensation gate signal GC. The third transistor T3 may include a gate that receives the compensation gate signal GC, a first terminal connected to the first node N1, and a second terminal connected to the second node N2.

The fourth transistor T4 may transmit the reference voltage VREF to the first node N1 in response to the initialization gate signal GI. The fourth transistor T4 may connect the data line DL that transmits the data signal DS having the reference voltage VREF to the first node N1 in response to the initialization gate signal GI. The fourth transistor T4 may include a gate that receives the initialization gate signal GI, a first terminal connected to the data line DL, and a second terminal connected to the first node N1.

The fifth transistor T5 may connect the second node N2 to the first terminal of the light-emitting element EL in response to the emission signal EM. The fifth transistor T5 may include a gate that receives the emission signal EM, a first terminal connected to the second node N2, and a second terminal connected to the first terminal of the light-emitting element EL.

According to some embodiments, as illustrated in FIG. 2, each of the first transistor T1, the second transistor T2, the third transistor T3, the fourth transistor T4, and the fifth transistor T5 may be a p-type transistor (e.g., a PMOS transistor). According to some embodiments, at least one of the first transistor T1, the second transistor T2, the third transistor T3, the fourth transistor T4, or the fifth transistor T5 may be an n-type transistor (e.g., an NMOS transistor).

The first capacitor C1 may be connected between the first node N1 and the third node N3. The first capacitor C1 may include a first terminal connected to the first node N1 and a second terminal connected to the third node N3.

The second capacitor C2 may be connected between the third node N3 and a power line PL that transmits the high power voltage ELVDD. The second capacitor C2 may include a first terminal connected to the third node N3 and a second terminal connected to the power line PL.

A frame period of the pixel PX1 may include an initialization period P1, a compensation period P2, a writing period P3, and an emission period P4. In the initialization period P1, the first node N1, the second node N2, the third node N3, and the first terminal of the light-emitting element EL may be initialized. In the compensation period P2, a threshold voltage of the first transistor T1 may be compensated. In the writing period P3, the data voltage VDAT may be written to the gate of the first transistor T1. In the emission period P4, the light-emitting element EL may emit light.

The data signal DS may have the reference voltage VREF in the initialization period P1, the compensation period P2, and the emission period P4, and may have the data voltage VDAT in the writing period P3. For example, a voltage level of the reference voltage VREF may be 0 V (or about 0 V).

The compensation gate signal GC may have an activation voltage level (e.g., −10 V or about −10 V) in the initialization period P1 and the compensation period P2, and may have a deactivation voltage level (e.g., 10 V or about 10 V) in the writing period P3 and the emission period P4.

The initialization gate signal GI may have an activation voltage level (e.g., −10 V or about −10 V) in the initialization period P1, and may have a deactivation voltage level (e.g., 10 V or about 10 V) in the compensation period P2, the writing period P3, and the emission period P4.

The write gate signal GW may have an activation voltage level (e.g., −10 V or about −10 V) in the initialization period P1, the compensation period P2, and the writing period P3, and may have a deactivation voltage level (e.g., 10 V or about 10 V) in the emission period P4.

The emission signal EM may have an activation voltage level (e.g., −10 V or about −10 V) in the initialization period P1 and the emission period P4, and may have a deactivation voltage level (e.g., 10 V or about 10 V) in the compensation period P2 and the writing period P3.

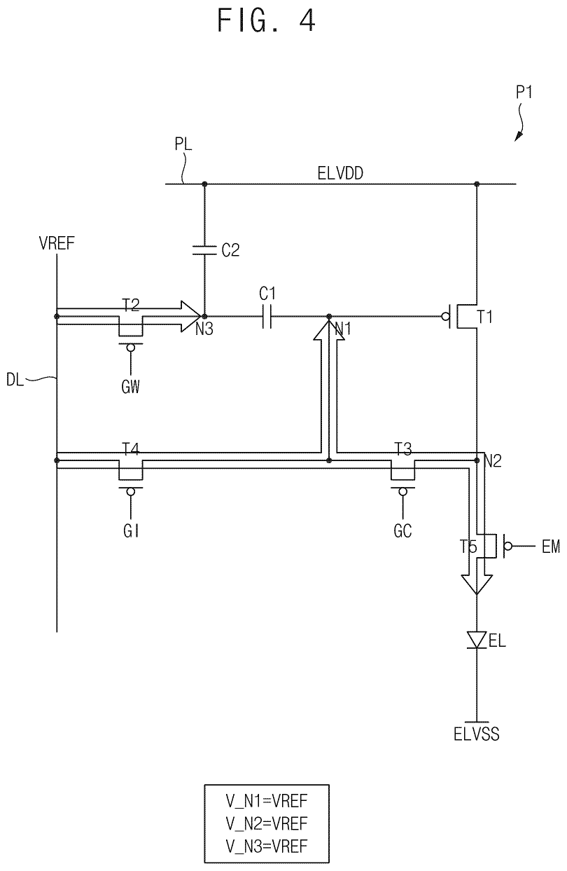

FIG. 4 is a diagram for describing the initialization period P1 of FIG. 3.

Referring to FIGS. 3 and 4, in the initialization period P1, the data signal DS may have the reference voltage VREF, and each of the compensation gate signal GC, the initialization gate signal GI, the write gate signal GW, and the emission signal EM may have the activation voltage level. In the initialization period P1, the reference voltage VREF may be applied to the third node N3 through the second transistor T2 turned on in response to the activation voltage level of the write gate signal GW. In the initialization period P1, the reference voltage VREF may be applied to the first node N1 through the fourth transistor T4 turned on in response to the activation voltage level of the initialization gate signal GI, the reference voltage VREF may be applied to the second node N2 through the third transistor T3 turned on in response to the activation voltage level of the compensation gate signal GC, and the reference voltage VREF may be applied to the first terminal of the light-emitting element EL through the fifth transistor T5 turned on in response to the activation voltage level of the emission signal EM. In the initialization period P1, each of a voltage V_N1 of the first node N1, a voltage V_N2 of the second node N2, and a voltage V_N3 of the third node N3 may be VREF.

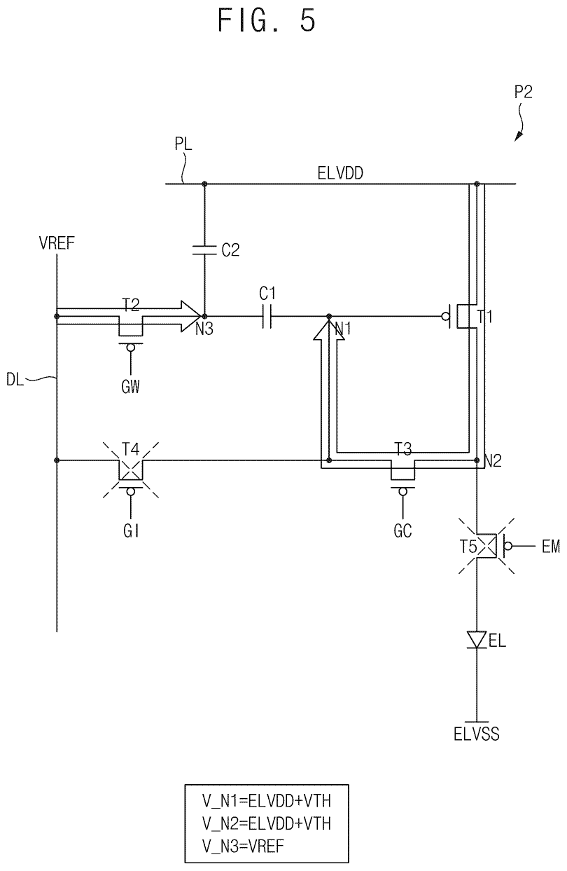

FIG. 5 is a diagram for describing the compensation period P2 of FIG. 3.

Referring to FIGS. 3 and 5, in the compensation period P2, the data signal DS may have the reference voltage VREF, each of the compensation gate signal GC and the write gate signal GW may have the activation voltage level, and each of the initialization gate signal GI and the emission signal EM may have the deactivation voltage level. In the compensation period P2, the reference voltage VREF may be applied to the third node N3 through the second transistor T2 turned on in response to the activation voltage level of the write gate signal GW. In the compensation period P2, a current path may be formed from the power line PL to the first node N1 through the turned-on first transistor T1 and the third transistor T3 turned on in response to the activation voltage level of the compensation gate signal GC, and a voltage level of the first node N1 may increase until the first transistor T1 is turned off (until a voltage difference VGS between the gate and the first terminal of the first transistor T1 becomes equal to a threshold voltage VTH of the first transistor T1). Accordingly, in the compensation period P2, the voltage V_N1 of the first node N1 may be equal to a value ELVDD+VTH obtained by adding the threshold voltage VTH of the first transistor T1 to the high power voltage ELVDD. In the compensation period P2, each of the voltage V_N1 of the first node N1 and the voltage V_N2 of the second node N2 may be ELVDD+VTH, and the voltage V_N3 of the third node N3 may be VREF.

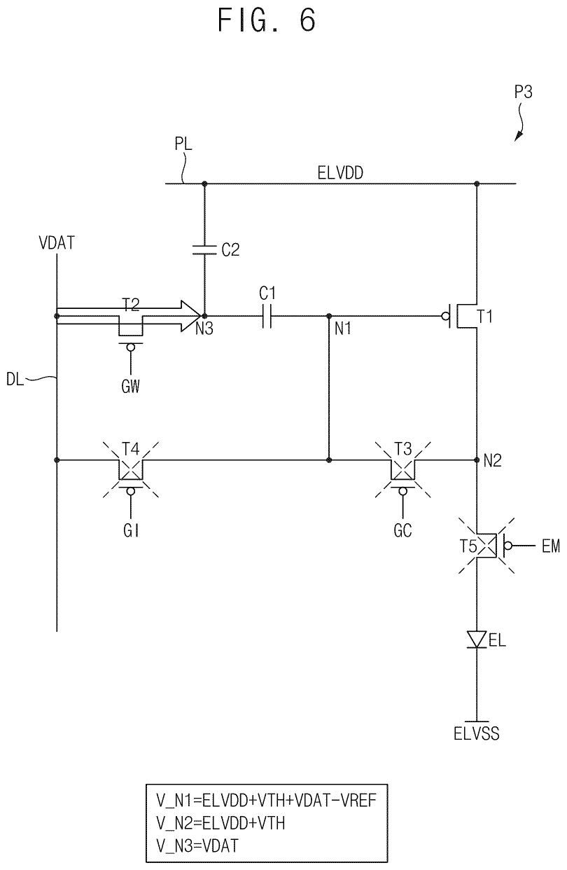

FIG. 6 is a diagram for describing the writing period P3 of FIG. 3.

Referring to FIGS. 3 and 6, in the writing period P3, the data signal DS may have the data voltage VDAT, the write gate signal GW may have the activation voltage level, and each of the compensation gate signal GC, the initialization gate signal GI, and the emission signal EM may have the deactivation voltage level. In the writing period P3, the data voltage VDAT may be applied to the third node N3 through the second transistor T2 turned on in response to the activation voltage level of the write gate signal GW, and accordingly, the voltage V_N3 of the third node N3 may change from the reference voltage VREF to the data voltage VDAT. Due to a coupling effect of the first capacitor C1, the voltage V_N1 of the first node N1 in the writing period P3 may be calculated by mathematical formula 1.

V_N1=ELVDD+VTH+VDAT−VREF Mathematical Formula 1

In the write period P3, the voltage V_N1 of the first node N1 may be ELVDD+VTH+VDAT−VREF, the voltage V_N2 of the second node N2 may be ELVDD+VTH, and the voltage V_N3 of the third node N3 may be VDAT.

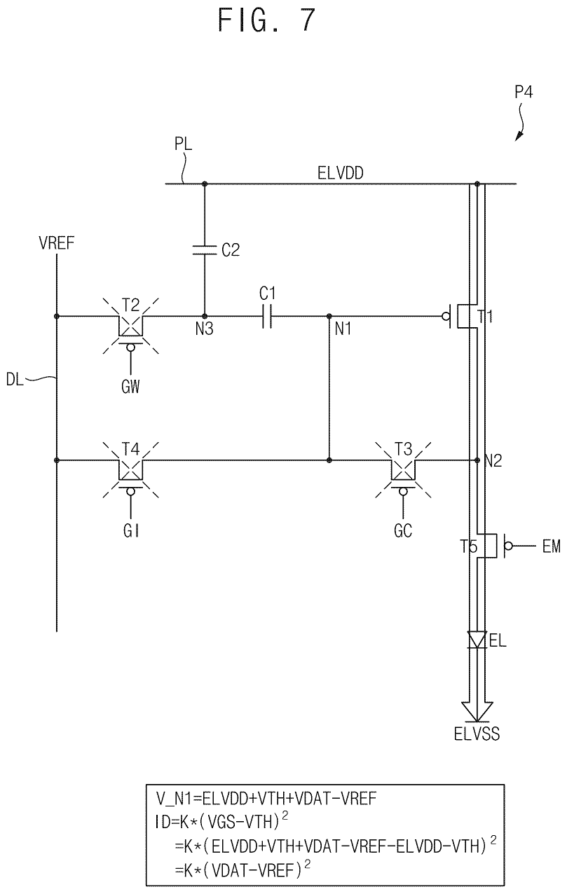

FIG. 7 is a diagram for describing the emission period P4 of FIG. 3.

Referring to FIGS. 3 and 7, in the emission period P4, the data signal DS may have the reference voltage VREF, the emission signal EM may have the activation voltage level, and each of the compensation gate signal GC, the initialization gate signal GI, and the write gate signal GW may have the deactivation voltage level. In the emission period P4, a current path may be formed from the power line PL that transmits the high power voltage ELVDD to a line that transmits the low power voltage ELVSS through the turned-on first transistor T1, the fifth transistor T5 turned on in response to the activation voltage level of the emission signal EM, and the light-emitting element EL, and a driving current ID may flow through the current path. In the emission period P4, the light-emitting element EL may emit light with a luminance corresponding to the driving current ID. The driving current ID in the emission period P4 may be calculated by mathematical formula 2.

ID=K×(VGS−VTH)²=K×(ELVDD+VTH+VDAT−VREF−ELVDD−VTH)²=K×(VDAT−VREF)² Mathematical Formula 2

In mathematical formula 2, K is a proportional constant. According to mathematical formula 2, the driving current ID may be determined by the data voltage VDAT regardless of the threshold voltage VTH of the first transistor T1, and the light-emitting element EL may emit light with a luminance corresponding to the data voltage VDAT in the emission period P4.

In the display device 100 and pixel PX1 described with reference to FIGS. 1 to 7, the pixel PX1 includes a relatively small number of transistors, so that an area of the pixel PX1 may decrease, and a resolution of the display device 100 may increase. Further, the pixel PX1 compensates for the threshold voltage VTH of the driving transistor T1 in a diode-connection manner, so that an image quality of the display device 100 may be relatively improved.

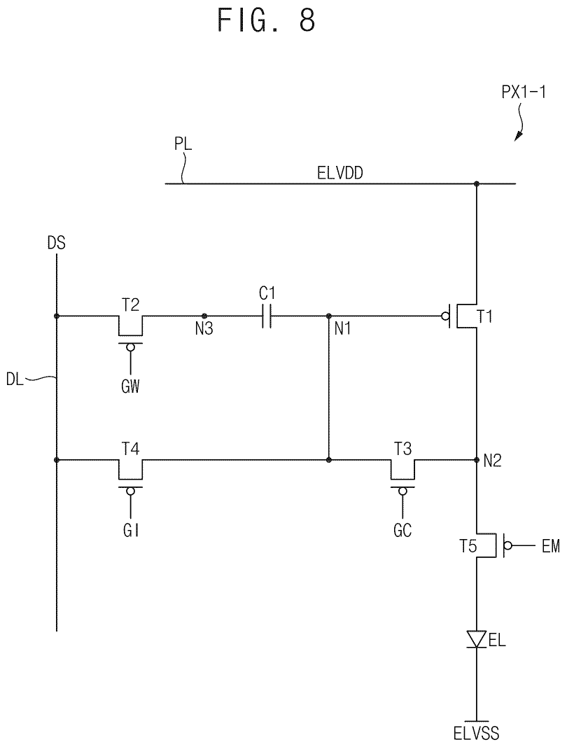

FIG. 8 is a circuit diagram illustrating a pixel PX1-1 according to some embodiments. The pixel PX1-1 of FIG. 8 may be an example of the pixel PX of FIG. 1.

Referring to FIGS. 3 and 8, the pixel PX1-1 may receive a write gate signal GW, a compensation gate signal GC, an initialization gate signal GI, an emission signal EM, a data signal DS, a high power voltage ELVDD, and a low power voltage ELVSS. The pixel PX1-1 may include a light-emitting element EL, a first transistor T1, a second transistor T2, a third transistor T3, a fourth transistor T4, a fifth transistor T5, and a first capacitor C1. The pixel PX1-1 of FIG. 8 may be the same or substantially the same as or similar to the pixel PX1 of FIG. 2 except for not including the second capacitor C2.

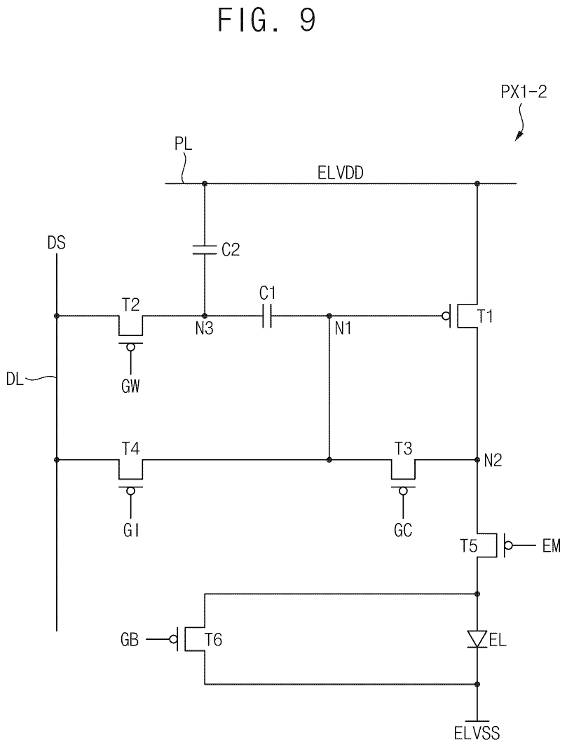

FIG. 9 is a circuit diagram illustrating a pixel PX1-2 according to some embodiments. The pixel PX1-2 of FIG. 9 may be an example of the pixel PX of FIG. 1. Although FIG. 9 illustrates various components in a pixel PX1-2 according to some embodiments, embodiments according to the present disclosure are not limited thereto, and according to various embodiments, the pixel may include additional components, or fewer components, without departing from the spirit and scope of embodiments according to the present disclosure.

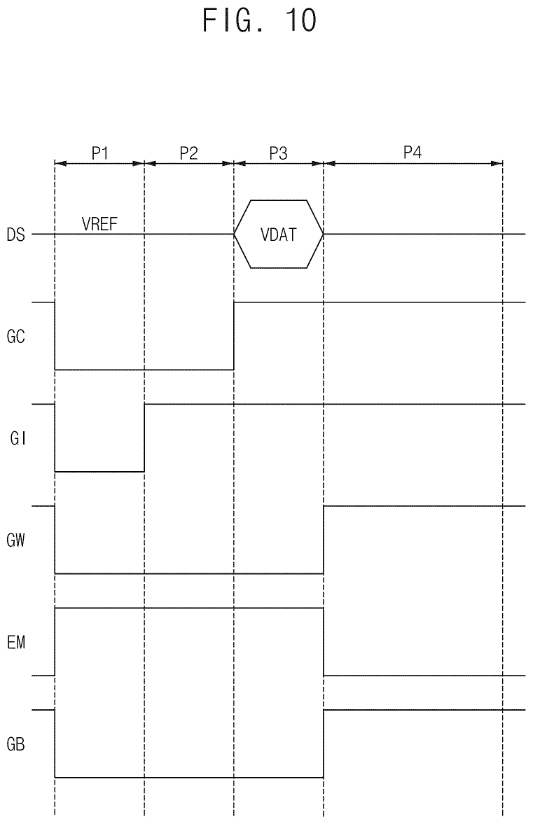

FIG. 10 is a timing diagram illustrating an example of signals DS, GC, GI, GW, EM, and GB of FIG. 10.

Referring to FIGS. 9 and 10, the pixel PX1-2 may receive a write gate signal GW, a compensation gate signal GC, an initialization gate signal GI, a bypass gate signal GB, an emission signal EM, a data signal DS, a high power voltage ELVDD, and a low power voltage ELVSS. The gate signal GS of FIG. 1 may include the write gate signal GW, the compensation gate signal GC, the initialization gate signal GI, and the bypass gate signal GB. The pixel PX1-2 may include a light-emitting element EL, a first transistor T1, a second transistor T2, a third transistor T3, a fourth transistor T4, a fifth transistor T5, a sixth transistor T6, a first capacitor C1, and a second capacitor C2. The pixel PX1-2 of FIG. 9 may be the same or substantially the same as or similar to the pixel PX1 of FIG. 2, except for further including the sixth transistor T6.

The sixth transistor T6 may transmit the low power voltage ELVSS to the first terminal of the light-emitting element EL in response to the bypass gate signal GB. The sixth transistor T6 may include a gate that receives the bypass gate signal GB, a first terminal that receives the low power voltage ELVSS, and a second terminal connected to the first terminal of the light-emitting element EL.

According to some embodiments, as illustrated in FIG. 9, each of the first transistor T1, the second transistor T2, the third transistor T3, the fourth transistor T4, the fifth transistor T5, and the sixth transistor T6 may be a p-type transistor (e.g., a PMOS transistor). According to some embodiments, at least one of the first transistor T1, the second transistor T2, the third transistor T3, the fourth transistor T4, the fifth transistor T5, or the sixth transistor T6 may be an n-type transistor (e.g., an NMOS transistor).

The emission signal EM may have a deactivation voltage level (e.g., 10 V or about 10 V) in the initialization period P1, the compensation period P2, and the writing period P3, and may have an activation voltage level (e.g., −10 V or about −10 V) in the emission period P4.

The bypass gate signal GB may have an activation voltage level (e.g., −10 V or about −10 V) in the initialization period P1, the compensation period P2, and the writing period P3, and may have a deactivation voltage level (e.g., 10 V or about 10 V) in the emission period P4.

In the initialization period P1, the data signal DS may have the reference voltage VREF, and each of the compensation gate signal GC, the initialization gate signal GI, the write gate signal GW, and the bypass gate signal GB may have the activation voltage level, and the emission signal EM may have the deactivation voltage level. In the initialization period P1, the reference voltage VREF may be applied to a third node N3 through the second transistor T2 turned on in response to the activation voltage level of the write gate signal GW. In the initialization period P1, the reference voltage VREF may be applied to the first node N1 through the fourth transistor T4 turned on in response to the activation voltage level of the initialization gate signal GI, and the reference voltage VREF may be applied to the second node N2 through the third transistor T3 turned on in response to the activation voltage level of the compensation gate signal GC. In the initialization period P1, the low power voltage ELVSS may be applied to the first terminal of the light-emitting element EL through the sixth transistor T6 turned on in response to the activation voltage level of the bypass gate signal GB.

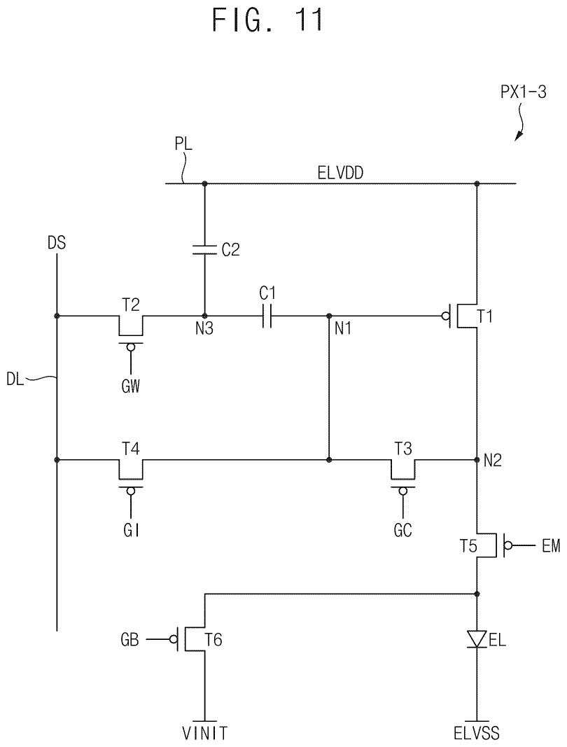

FIG. 11 is a circuit diagram illustrating a pixel PX1-3 according to some embodiments. The pixel PX1-3 of FIG. 11 may be an example of the pixel PX of FIG. 1. Although FIG. 11 illustrates various components in a pixel PX1-3 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 10 and 11, the pixel PX1-3 may receive a write gate signal GW, a compensation gate signal GC, an initialization gate signal GI, a bypass gate signal GB, an emission signal EM, a data signal DS, an initialization voltage VINIT, a high power voltage ELVDD, and a low power voltage ELVSS. The pixel PX1-3 may include a light-emitting element EL, a first transistor T1, a second transistor T2, a third transistor T3, a fourth transistor T4, a fifth transistor T5, a sixth transistor T6, a first capacitor C1, and a second capacitor C2. The pixel PX1-3 of FIG. 11 may be the same or substantially the same as or similar to the pixel PX1-2 of FIG. 9, except that the sixth transistor T6 transmits the initialization voltage VINIT.

The sixth transistor T6 may transmit the initialization voltage VINIT to the first terminal of the light-emitting element EL in response to the bypass gate signal GB. The sixth transistor T6 may include a gate that receives the bypass gate signal GB, a first terminal that receives the initialization voltage VINIT, and a second terminal connected to the first terminal of the light-emitting element EL. [00106]A voltage level of the initialization voltage VINIT may vary depending on a color of light emitted by the light-emitting element EL. According to some embodiments, a voltage level of the initialization voltage VINIT received by the pixel PX1-3 including a light-emitting element EL emitting red light, a voltage level of the initialization voltage VINIT received by the pixel PX1-3 including a light-emitting element EL emitting green light, and a voltage level of the initialization voltage VINIT received by the pixel PX1-3 including a light-emitting element EL emitting blue light may be different from each other.

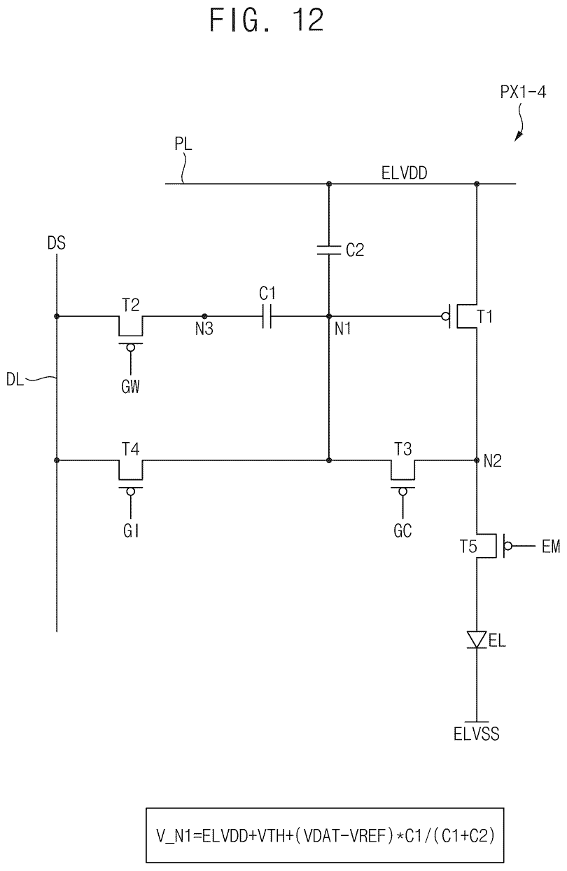

FIG. 12 is a circuit diagram illustrating a pixel PX1-4 according to some embodiments. The pixel PX1-4 of FIG. 12 may be an example of the pixel PX of FIG. 1. Although FIG. 12 illustrates various components in a pixel PX1-4 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 3 and 12, the pixel PX1-4 may receive a write gate signal GW, a compensation gate signal GC, an initialization gate signal GI, an emission signal EM, a data signal DS, a high power voltage ELVDD, and a low power voltage ELVSS. The pixel PX1-4 may include a light-emitting element EL, a first transistor T1, a second transistor T2, a third transistor T3, a fourth transistor T4, a fifth transistor T5, a first capacitor C1, and a second capacitor C2. The pixel PX1-4 of FIG. 12 may be the same or substantially the same as or similar to the pixel PX1 of FIG. 2, except for a position of the second capacitor C2.

The second capacitor C2 may be connected between the first node N1 and the power line PL. The second capacitor C2 may include a first terminal connected to the first node N1 and a second terminal connected to the power line PL.

In the writing period P3, the data voltage VDAT may be applied to the third node N3 through the second transistor T2 turned on in response to the activation voltage level of the write gate signal GW, and accordingly, the voltage of the third node N3 may change from the reference voltage VREF to the data voltage VDAT. Due to the coupling effect of the first capacitor C1, the voltage V_N1 of the first node N1 in the writing period P3 may be calculated by mathematical formula 3.

$$V\_N1 = ELVDD + VTH + ( VDAT - VREF ) \times \frac{C 1}{C 1 + C 2} \qquad Mathematical Formula 3$$

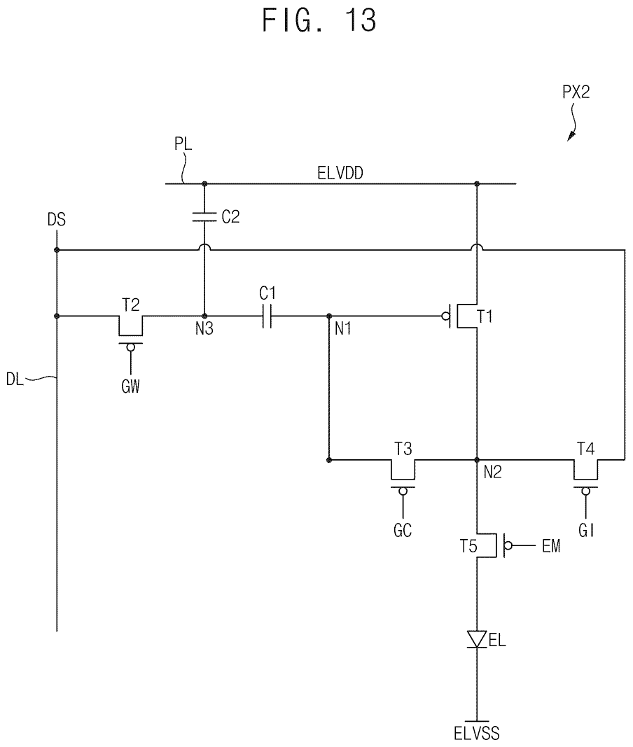

FIG. 13 is a circuit diagram illustrating a pixel PX2 according to some embodiments. The pixel PX2 of FIG. 13 may be an example of the pixel PX of FIG. 1. Although FIG. 13 illustrates various components in a pixel PX2 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 3 and 13, the pixel PX2 may receive a write gate signal GW, a compensation gate signal GC, an initialization gate signal GI, an emission signal EM, a data signal DS, a high power voltage ELVDD, and a low power voltage ELVSS. The pixel PX2 may include a light-emitting element EL, a first transistor T1, a second transistor T2, a third transistor T3, a fourth transistor T4, a fifth transistor T5, a first capacitor C1, and a second capacitor C2. The pixel PX2 of FIG. 13 may be the same or substantially the same as or similar to the pixel PX1 of FIG. 2, except for a position of the fourth transistor T4.

The fourth transistor T4 may transmit the reference voltage VREF to the second node N2 in response to the initialization gate signal GI. The fourth transistor T4 may connect the data line DL that transmits the data signal DS having the reference voltage VREF to the second node N2 in response to the initialization gate signal GI. The fourth transistor T4 may include a gate that receives the initialization gate signal GI, a first terminal connected to the data line DL, and a second terminal connected to the second node N2.

In the initialization period P1, the reference voltage VREF may be applied to the third node N3 through the second transistor T2 turned on in response to the activation voltage level of the write gate signal GW. In the initialization period P1, the reference voltage VREF may be applied to the second node N2 through a fourth transistor T4 turned on in response to the activation voltage level of the initialization gate signal GI, the reference voltage VREF may be applied to the first node N1 through the third transistor T3 turned on in response to the activation voltage level of the compensation gate signal GC, and the reference voltage VREF may be applied to the first terminal of the light-emitting element EL through the fifth transistor T5 turned on in response to the activation voltage level of the emission signal EM.

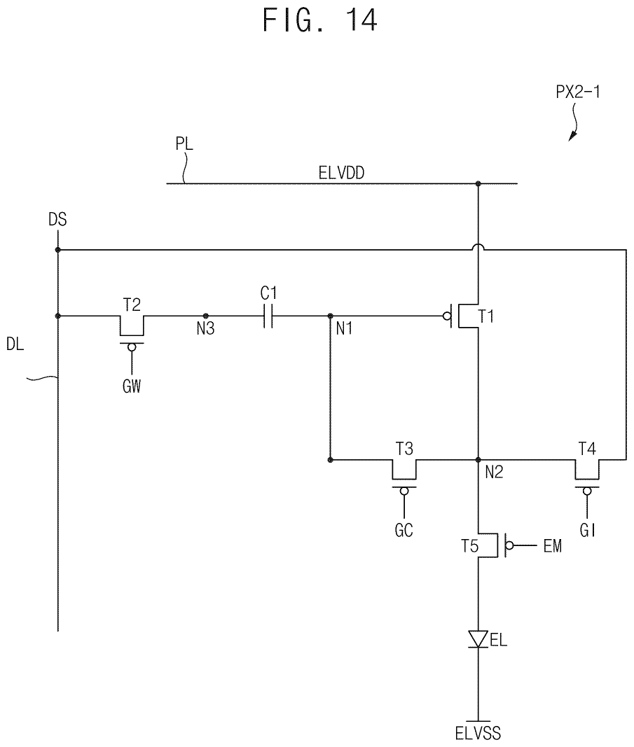

FIG. 14 is a circuit diagram illustrating a pixel PX2-1 according to some embodiments. The pixel PX2-1 of FIG. 14 may be an example of the pixel PX of FIG. 1. Although FIG. 14 illustrates various components in a pixel PX2-1 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 3 and 14, the pixel PX2-1 may receive a write gate signal GW, a compensation gate signal GC, an initialization gate signal GI, an emission signal EM, a data signal DS, a high power voltage ELVDD, and a low power voltage ELVSS. The pixel PX2-1 may include a light-emitting element EL, a first transistor T1, a second transistor T2, a third transistor T3, a fourth transistor T4, a fifth transistor T5, and a first capacitor C1. The pixel PX2-1 of FIG. 14 may be the same or substantially the same as or similar to the pixel PX2 of FIG. 13, except for not including the second capacitor C2.

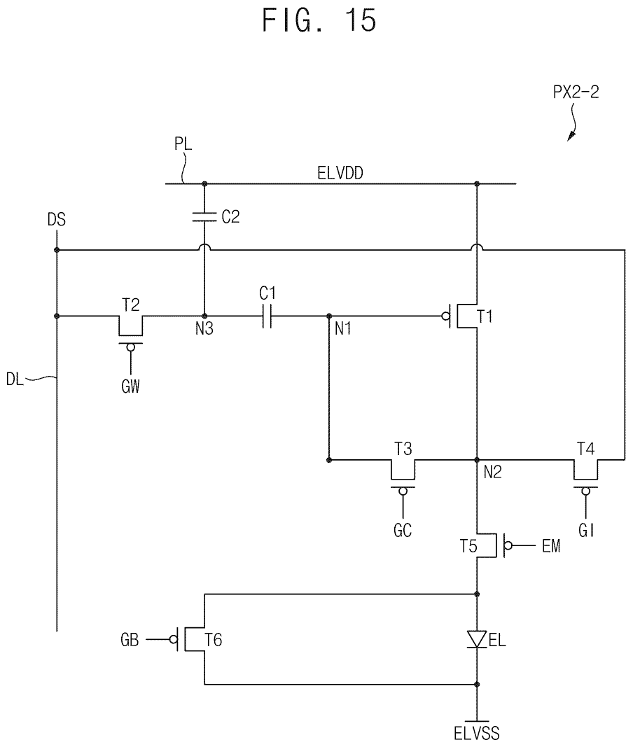

FIG. 15 is a circuit diagram illustrating a pixel PX2-2 according to some embodiments. The pixel PX2-2 of FIG. 15 may be an example of the pixel PX of FIG. 1. Although FIG. 15 illustrates various components in a pixel PX2-2 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 10 and 15, the pixel PX2-2 may receive a write gate signal GW, a compensation gate signal GC, an initialization gate signal GI, a bypass gate signal GB, an emission signal EM, a data signal DS, a high power voltage ELVDD, and a low power voltage ELVSS. The pixel PX2-2 may include a light-emitting element EL, a first transistor T1, a second transistor T2, a third transistor T3, a fourth transistor T4, a fifth transistor T5, a sixth transistor T6, a first capacitor C1, and a second capacitor C2. The pixel PX2-2 of FIG. 15 may be the same or substantially the same as or similar to the pixel PX2 of FIG. 13, except for further including the sixth transistor T6.

The sixth transistor T6 may transmit the low power voltage ELVSS to the first terminal of the light-emitting element EL in response to the bypass gate signal GB. The sixth transistor T6 may include a gate that receives the bypass gate signal GB, a first terminal that receives the low power voltage ELVSS, and a second terminal connected to the first terminal of the light-emitting element EL.

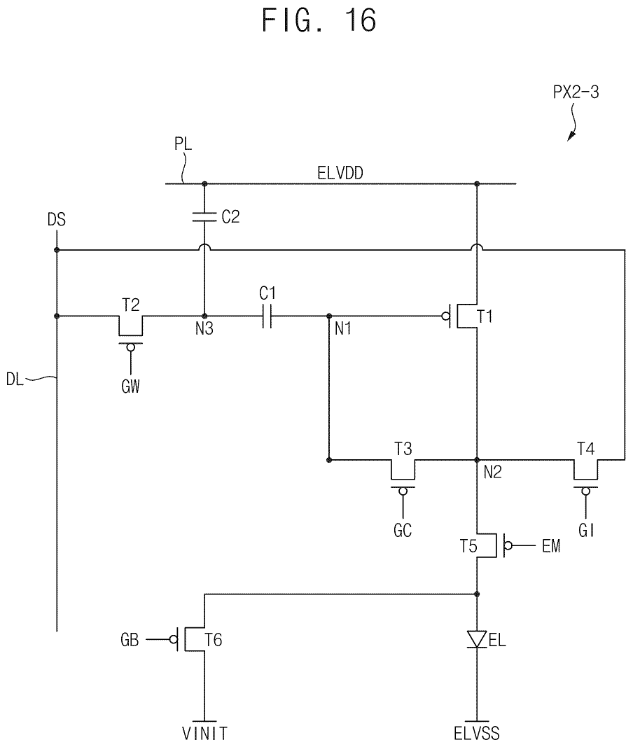

FIG. 16 is a circuit diagram illustrating a pixel PX2-3 according to some embodiments. The pixel PX2-3 of FIG. 16 may be an example of the pixel PX of FIG. 1. Although FIG. 16 illustrates various components in a pixel PX2-3 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 10 and 16, the pixel PX2-3 may receive a write gate signal GW, a compensation gate signal GC, an initialization gate signal GI, a bypass gate signal GB, an emission signal EM, a data signal DS, an initialization voltage VINIT, a high power voltage ELVDD, and a low power voltage ELVSS. The pixel PX2-3 may include a light-emitting element EL, a first transistor T1, a second transistor T2, a third transistor T3, a fourth transistor T4, a fifth transistor T5, a sixth transistor T6, a first capacitor C1, and a second capacitor C2. The pixel PX2-3 of FIG. 16 may be the same or substantially the same as or similar to the pixel PX2-2 of FIG. 15, except that the sixth transistor T6 transmits the initialization voltage VINIT.

The sixth transistor T6 may transmit the initialization voltage VINIT to the first terminal of the light-emitting element EL in response to the bypass gate signal GB. The sixth transistor T6 may include a gate that receives the bypass gate signal GB, a first terminal that receives the initialization voltage VINIT, and a second terminal connected to the first terminal of the light-emitting element EL.

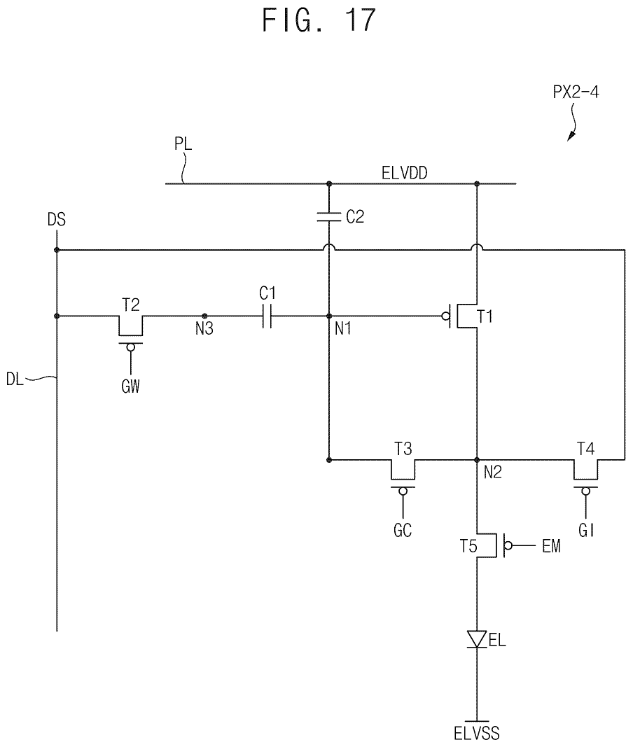

FIG. 17 is a circuit diagram illustrating a pixel PX2-4 according to some embodiments. The pixel PX2-4 of FIG. 17 may be an example of the pixel PX of FIG. 1. Although FIG. 17 illustrates various components in a pixel PX2-4 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 3 and 17, the pixel PX2-4 may receive a write gate signal GW, a compensation gate signal GC, an initialization gate signal GI, an emission signal EM, a data signal DS, a high power voltage ELVDD, and a low power voltage ELVSS. The pixel PX2-4 may include a light-emitting element EL, a first transistor T1, a second transistor T2, a third transistor T3, a fourth transistor T4, a fifth transistor T5, a first capacitor C1, and a second capacitor C2. The pixel PX2-4 of FIG. 17 may be the same or substantially the same as or similar to the pixel PX2 of FIG. 13, except for a position of the second capacitor C2.

The second capacitor C2 may be connected between the first node N1 and the power line PL. The second capacitor C2 may include a first terminal connected to the first node N1 and a second terminal connected to a power line PL.

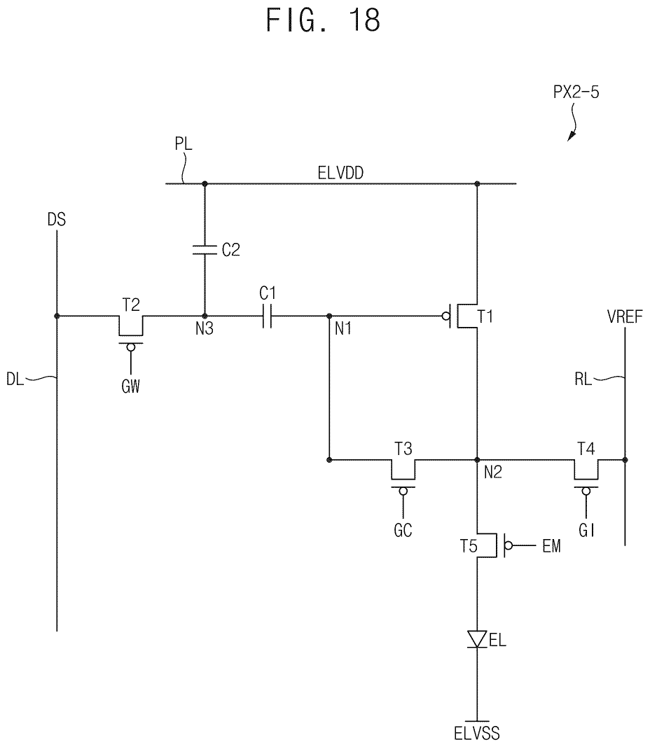

FIG. 18 is a circuit diagram illustrating a pixel PX2-5 according to some embodiments. The pixel PX2-5 of FIG. 18 may be an example of the pixel PX of FIG. 1. Although FIG. 18 illustrates various components in a pixel PX2-5 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 3 and 18, the pixel PX2-5 may receive a write gate signal GW, a compensation gate signal GC, an initialization gate signal GI, an emission signal EM, a data signal DS, a reference voltage VREF, a high power voltage ELVDD, and a low power voltage ELVSS. The pixel PX2-5 may include a light-emitting element EL, a first transistor T1, a second transistor T2, a third transistor T3, a fourth transistor T4, a fifth transistor T5, a first capacitor C1, and a second capacitor C2. The pixel PX2-5 of FIG. 18 may be the same or substantially the same as or similar to the pixel PX2 of FIG. 13, except for a connection of the fourth transistor T4.

The fourth transistor T4 may transmit the reference voltage VREF to the second node N2 in response to the initialization gate signal GI. The fourth transistor T4 may connect a reference line RL that transmits the reference voltage VREF in response to the initialization gate signal GI to the second node N2. The fourth transistor T4 may include a gate that receives the initialization gate signal GI, a first terminal connected to the reference line RL, and a second terminal connected to the second node N2.

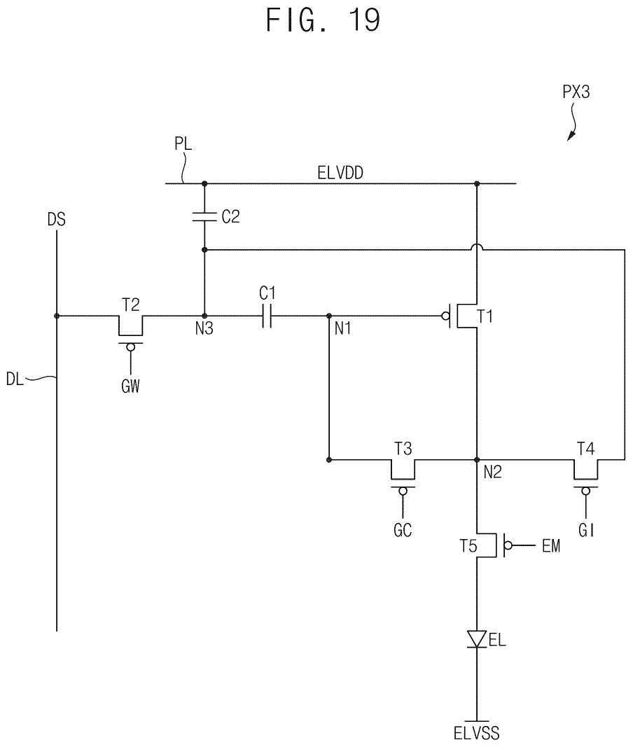

FIG. 19 is a circuit diagram illustrating a pixel PX3 according to some embodiments. The pixel PX3 of FIG. 19 may be an example of the pixel PX of FIG. 1. Although FIG. 19 illustrates various components in a pixel PX3 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 3 and 19, the pixel PX3 may receive a write gate signal GW, a compensation gate signal GC, an initialization gate signal GI, an emission signal EM, a data signal DS, a high power voltage ELVDD, and a low power voltage ELVSS. The pixel PX3 may include a light-emitting element EL, a first transistor T1, a second transistor T2, a third transistor T3, a fourth transistor T4, a fifth transistor T5, a first capacitor C1, and a second capacitor C2. The pixel PX3 of FIG. 19 may be the same or substantially the same as or similar to the pixel PX1 of FIG. 2, except for a position of the fourth transistor T4.

The fourth transistor T4 may connect the second node N2 to the third node N3 in response to the initialization gate signal GI. The fourth transistor T4 may include a gate that receives the initialization gate signal GI, a first terminal connected to the third node N3, and a second terminal connected to the second node N2.

In the initialization period P1, the reference voltage VREF may be applied to the third node N3 through the second transistor T2 turned on in response to the activation voltage level of the write gate signal GW, the reference voltage VREF may be applied to the second node N2 through the fourth transistor T4 turned on in response to the activation voltage level of the initialization gate signal GI, the reference voltage VREF may be applied to the first node N1 through the third transistor T3 turned on in response to the activation voltage level of the compensation gate signal GC, and the reference voltage VREF may be applied to the first terminal of the light-emitting element EL through the fifth transistor T5 turned on in response to the activation voltage level of the emission signal EM.

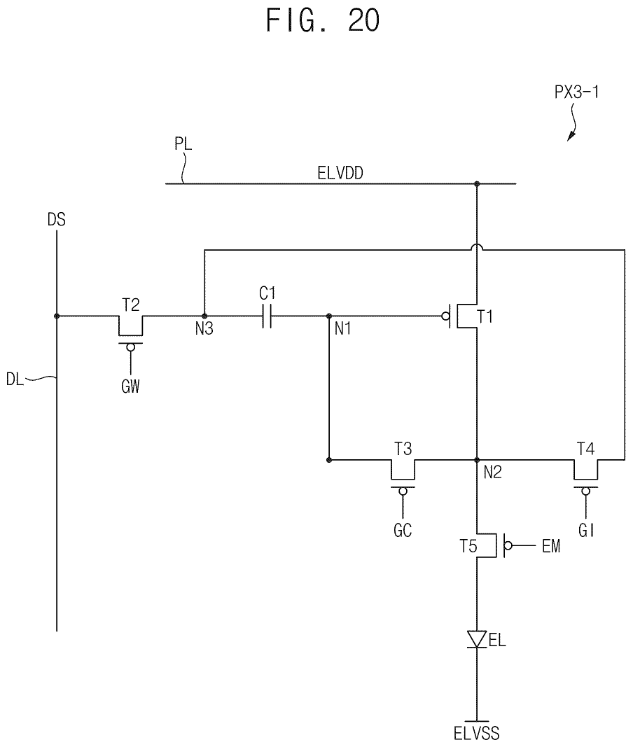

FIG. 20 is a circuit diagram illustrating a pixel PX3-1 according to some embodiments. The pixel PX3-1 of FIG. 20 may be an example of the pixel PX of FIG. 1. Although FIG. 20 illustrates various components in a pixel PX3-1 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 3 and 20, the pixel PX3-1 may receive a write gate signal GW, a compensation gate signal GC, an initialization gate signal GI, an emission signal EM, a data signal DS, a high power voltage ELVDD, and a low power voltage ELVSS. The pixel PX3-1 may include a light-emitting element EL, a first transistor T1, a second transistor T2, a third transistor T3, a fourth transistor T4, a fifth transistor T5, and a first capacitor C1. The pixel PX3-1 of FIG. 20 may be the same or substantially the same as or similar to the pixel PX3 of FIG. 19, except for not including the second capacitor C2.

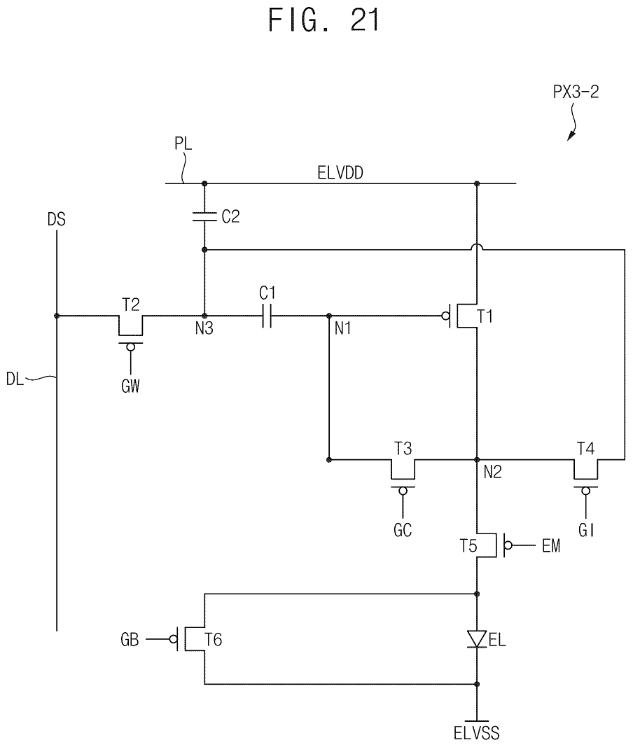

FIG. 21 is a circuit diagram illustrating a pixel PX3-2 according to some embodiments. The pixel PX3-2 of FIG. 21 may be an example of the pixel PX of FIG. 1. Although FIG. 21 illustrates various components in a pixel PX3-2 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 10 and 21, the pixel PX3-2 may receive a write gate signal GW, a compensation gate signal GC, an initialization gate signal GI, a bypass gate signal GB, an emission signal EM, a data signal DS, a high power voltage ELVDD, and a low power voltage ELVSS. The pixel PX3-2 may include a light-emitting element EL, a first transistor T1, a second transistor T2, a third transistor T3, a fourth transistor T4, a fifth transistor T5, a sixth transistor T6, a first capacitor C1, and a second capacitor C2. The pixel PX3-2 of FIG. 21 may be the same or substantially the same as or similar to the pixel PX3 of FIG. 19, except for further including the sixth transistor T6.

The sixth transistor T6 may transmit the low power voltage ELVSS to the first terminal of the light-emitting element EL in response to the bypass gate signal GB. The sixth transistor T6 may include a gate that receives the bypass gate signal GB, a first terminal that receives the low power voltage ELVSS, and a second terminal connected to the first terminal of the light-emitting element EL.

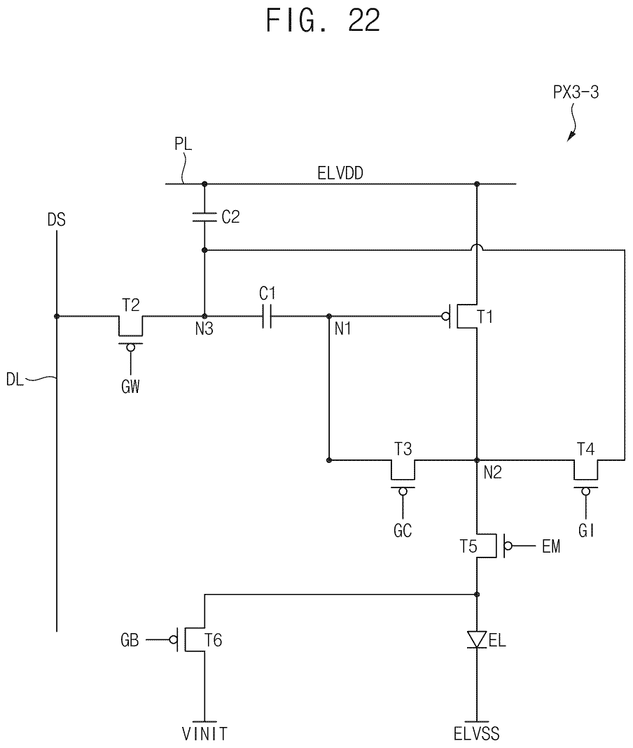

FIG. 22 is a circuit diagram illustrating a pixel PX3-3 according to some embodiments. The pixel PX3-3 of FIG. 22 may be an example of the pixel PX of FIG. 1. Although FIG. 22 illustrates various components in a pixel PX3-2 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 10 and 22, the pixel PX3-3 may receive a write gate signal GW, a compensation gate signal GC, an initialization gate signal GI, a bypass gate signal GB, an emission signal EM, a data signal DS, an initialization voltage VINIT, a high power voltage ELVDD, and a low power voltage ELVSS. The pixel PX3-3 may include a light-emitting element EL, a first transistor T1, a second transistor T2, a third transistor T3, a fourth transistor T4, a fifth transistor T5, a sixth transistor T6, a first capacitor C1, and a second capacitor C2. The pixel PX3-3 of FIG. 22 may be the same or substantially the same as or similar to the pixel PX3-2 of FIG. 21, except that the sixth transistor T6 transmits the initialization voltage VINIT.

The sixth transistor T6 may transmit the initialization voltage VINIT to the first terminal of the light-emitting element EL in response to the bypass gate signal GB. The sixth transistor T6 may include a gate that receives the bypass gate signal GB, a first terminal that receives the initialization voltage VINIT, and a second terminal connected to the first terminal of the light-emitting element EL.

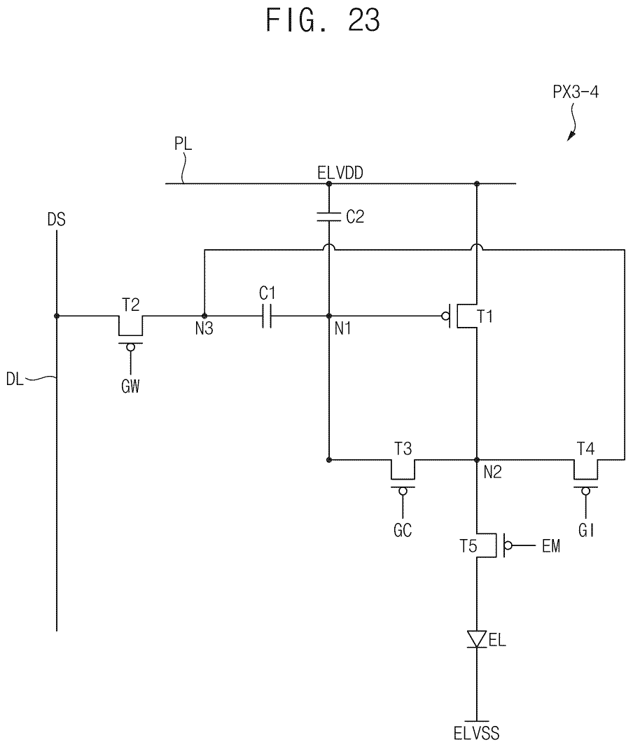

FIG. 23 is a circuit diagram illustrating a pixel PX3-4 according to some embodiments. The pixel PX3-4 of FIG. 23 may be an example of the pixel PX of FIG. 1. Although FIG. 23 illustrates various components in a pixel PX3-4 according to some embodiments, embodiments according to the present disclosure are not limited thereto, and according to various embodiments, the pixel may include additional components, or fewer components, without departing from the spirit and scope of embodiments according to the present disclosure.

Referring to FIGS. 3 and 23, the pixel PX3-4 may receive a write gate signal GW, a compensation gate signal GC, an initialization gate signal GI, an emission signal EM, a data signal DS, a high power voltage ELVDD, and a low power voltage ELVSS. The pixel PX3-4 may include a light-emitting element EL, a first transistor T1, a second transistor T2, a third transistor T3, a fourth transistor T4, a fifth transistor T5, a first capacitor C1, and a second capacitor C2. The pixel PX3-4 of FIG. 23 may be the same or substantially the same as or similar to the pixel PX3 of FIG. 19, except for a position of the second capacitor C2.

The second capacitor C2 may be connected between the first node N1 and the power line PL. The second capacitor C2 may include a first terminal connected to the first node N1 and a second terminal connected to the power line PL.

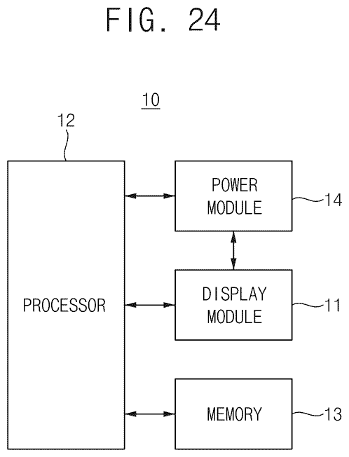

FIG. 24 is a block diagram illustrating an electronic device according to some embodiments.

Referring to FIG. 24, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), or a controller.

The memory 13 may store data information necessary for an operation of the processor 12 or the display module 11. When the processor 12 executes an application stored in the memory 13, the input image data IMD1 of FIG. 1 and the input control signal CNT0 of FIG. 1 may be transmitted to the display module 11, and the display module 11 may output image information based on the input image data IMD1 and the input control signal CNT0.

The power module 14 may include a power supply module such as a power adapter, a battery device, etc. and a power conversion module that converts power supplied by the power supply module to generate power required for an operation of the electronic device 10.

At least one of the components of the electronic device 10 described above may be included in the display device 100 of FIG. 1 according to some embodiments described above. Further, some of individual modules functionally included in one module may be included in the display device 100, and others may be provided separately from the display device 100. For example, the display device 100 may include the display module 11, and the processor 12, the memory 13, and the power module 14 may be provided in the form of other devices within the electronic device 10 other than the display device 100.

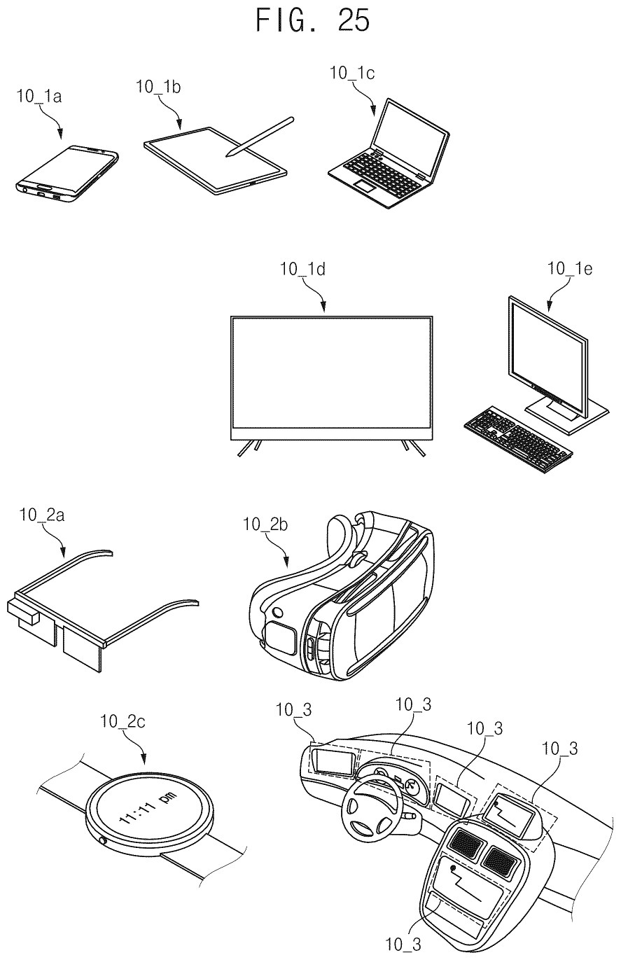

FIG. 25 is a diagram illustrating electronic devices according to some embodiments.

Referring to FIG. 25, electronic devices to which display devices according to some embodiments are applied may include not only image display electronic devices such as a smart phone 10_1a, a tablet PC 10_1b, a laptop 10_1c, a TV 10_1d, a desk monitor 10_1e, etc. but also wearable electronic devices including display modules such as smart glasses 10_2a, a head mounted display 10_2b, a smart watch 10_2c, etc., vehicle electronic devices 10_3 including display modules such as an instrument panel of an automobile, a center fascia, a center information display CID arranged on a dashboard, a room mirror display, etc.

The display device according to some embodiments may be applied to a display device included in a computer, a notebook, a mobile phone, a smart phone, a smart pad, a smart watch, a PMP, a PDA, an MP3 player, or the like.

Although aspects of the display device, the pixel, and the electronic device according to some embodiments have been described with reference to the drawings, the illustrated embodiments are examples, and may be modified and changed by a person having ordinary knowledge in the relevant technical field without departing from the technical spirit described in the following claims, and their equivalents.

What is claimed is:

1. A display device, comprising:
a display panel comprising pixels;
a gate driver configured to provide a write gate signal, a compensation gate signal, and an initialization gate signal to each of the pixels;
an emission driver configured to provide an emission signal to each of the pixels; and
a data driver configured to provide a data signal to each of the pixels,
wherein each of the pixels comprises:
a light-emitting element comprising a first terminal and a second terminal configured to receive a low power voltage;
a first transistor comprising a gate connected to a first node, a first terminal configured to receive a high power voltage having a voltage level higher than a voltage level of the low power voltage, and a second terminal connected to a second node;
a second transistor configured to transmit the data signal to a third node in response to the write gate signal;
a third transistor configured to connect the first node to the second node in response to the compensation gate signal;
a fourth transistor configured to transmit a reference voltage to the first node or the second node or to connect the second node to the third node in response to the initialization gate signal;
a fifth transistor configured to connect the second node to the first terminal of the light-emitting element in response to the emission signal; and
a first capacitor connected between the first node and the third node.

2. The display device of claim 1, wherein the fourth transistor is configured to connect a data line configured to transmit the data signal having the reference voltage to the first node in response to the initialization gate signal.

3. The display device of claim 1, wherein, in an initialization period, the data signal has the reference voltage, and each of the compensation gate signal, the initialization gate signal, the write gate signal, and the emission signal has an activation voltage level.

4. The display device of claim 1, wherein, in a compensation period, the data signal has the reference voltage, each of the compensation gate signal and the write gate signal has an activation voltage level, and each of the initialization gate signal and the emission signal has a deactivation voltage level.

5. The display device of claim 1, wherein, in a writing period, the data signal has a data voltage, the write gate signal has an activation voltage level, and each of the compensation gate signal, the initialization gate signal, and the emission signal has a deactivation voltage level.

6. The display device of claim 1, wherein, in an emission period, the data signal has the reference voltage, the emission signal has an activation voltage level, and each of the compensation gate signal, the initialization gate signal, and the write gate signal has a deactivation voltage level.

7. The display device of claim 1, wherein each of the pixels further comprises:
a second capacitor connected between the third node and a power line configured to transmit the high power voltage.

8. The display device of claim 1, wherein each of the pixels further comprises:
a sixth transistor configured to transmit the low power voltage to the first terminal of the light-emitting element in response to a bypass gate signal.

9. The display device of claim 8, wherein the bypass gate signal has an activation voltage level in an initialization period, a compensation period, and a writing period, and has a deactivation voltage level in an emission period.

10. The display device of claim 1, wherein each of the pixels further comprises:
a sixth transistor configured to transmit an initialization voltage to the first terminal of the light-emitting element in response to a bypass gate signal.

11. The display device of claim 1, wherein each of the pixels further comprises:
a second capacitor connected between the first node and a power line configured to transmit the high power voltage.

12. The display device of claim 1, wherein the fourth transistor is configured to connect a data line configured to transmit the data signal having the reference voltage to the second node in response to the initialization gate signal.

13. The display device of claim 1, wherein the fourth transistor is configured to connect a reference line configured to transmit the reference voltage to the second node in response to the initialization gate signal.

14. The display device of claim 1, wherein the fourth transistor is configured to connect the second node to the third node in response to the initialization gate signal.

15. A pixel, comprising:
a light-emitting element comprising a first terminal and a second terminal configured to receive a low power voltage;
a first transistor comprising a gate connected to a first node, a first terminal configured to receive a high power voltage having a voltage level higher than a voltage level of the low power voltage, and a second terminal connected to a second node;
a second transistor configured to transmit a data signal to a third node in response to a write gate signal;
a third transistor configured to connect the first node to the second node in response to a compensation gate signal;
a fourth transistor configured to transmit a reference voltage to the first node or the second node or to connect the second node to the third node in response to an initialization gate signal;
a fifth transistor configured to connect the second node to the first terminal of the light-emitting element in response to an emission signal; and
a first capacitor connected between the first node and the third node.

16. The pixel of claim 15, wherein the fourth transistor is configured to connect a data line configured to transmit the data signal having the reference voltage to the first node in response to the initialization gate signal.

17. The pixel of claim 15, further comprising:
a second capacitor connected between the third node and a power line configured to transmit the high power voltage.

18. The pixel of claim 15, wherein the fourth transistor is configured to connect a data line configured to transmit the data signal having the reference voltage to the second node in response to the initialization gate signal.

19. The pixel of claim 15, wherein the fourth transistor is configured to connect the second node to the third node in response to the initialization gate signal.

20. An electronic device, comprising:
a processor configured to generate input image data;
a display device configured to display an image based on the input image data; and
a power module connected to the processor and the display device,
wherein the display device comprises:
a display panel comprising pixels;
a gate driver configured to provide a write gate signal, a compensation gate signal, and an initialization gate signal to each of the pixels;
an emission driver configured to provide an emission signal to each of the pixels; and
a data driver configured to provide a data signal to each of the pixels, and
wherein each of the pixels comprises:
a light-emitting element comprising a first terminal and a second terminal configured to receive a low power voltage;
a first transistor comprising a gate connected to a first node, a first terminal configured to receive a high power voltage having a voltage level higher than a voltage level of the low power voltage, and a second terminal connected to a second node;
a second transistor configured to transmit the data signal to a third node in response to the write gate signal;
a third transistor configured to connect the first node to the second node in response to the compensation gate signal;
a fourth transistor configured to transmit a reference voltage to the first node or the second node or to connect the second node to the third node in response to the initialization gate signal;
a fifth transistor configured to connect the second node to the first terminal of the light-emitting element in response to the emission signal; and
a first capacitor connected between the first node and the third node.
